(19) United States
(12) Patent Application Publication
(10) Pub. No.: US 2025/0358024 A1
(43) Pub. Date: Nov. 20, 2025

(54) CHANNEL STATE INFORMATION ENHANCEMENT FOR OVER-THE-AIR COHERENT JOINT TRANSMISSION CALIBRATION

(71) Applicant: Apple Inc., Cupertino, CA (US)

(72) Inventors: Haitong Sun, Saratoga, CA (US); Ankit Bhamri, Bad Nauheim (DE); Chunxuan Ye, San Diego, CA (US); Dawei Zhang, Saratoga, CA (US); Huaning Niu, San Jose, CA (US); Oghenekome Oteri, San Diego, CA (US); Wei Zeng, Saratoga, CA (US); Xiang Chen, Campbell, CA (US)

(21) Appl. No.: 19/284,887

(22) Filed: Jul. 30, 2025

Related U.S. Application Data
(63) Continuation of application No. 19/196,898, filed on May 2, 2025.
(60) Provisional application No. 63/644,950, filed on May 9, 2024.

(51) Int. Cl. H04B 17/11; H04L 5/00; H04W 24/10

(52) U.S. Cl. CPC H04B 17/11; H04L 5/0048; H04W 24/10

(57) ABSTRACT

Disclosed are methods, systems, and computer-readable medium to perform operations including decoding resource configuration data specifying a channel state information (CSI) reference signal (RS) resource configuration for performing one or more channel measurements for calibrating one or more transmissions from one or more transmission reception points (TRPs); and encoding, based on the CSI-RS resource configuration specified by the resource configuration data, a CSI report including one or more offset measurements for transmitting to the one or more TRPs for calibration of the one or more TRPs for a coherent joint transmission (CJTs).

### CLAIM OF PRIORITY

This application is a continuation of U.S. application Ser. No. 19/196,898, filed on May 2, 2025, which claims priority to U.S. Patent Application Ser. No. 63/644,950, filed on May 9, 2024, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In an aspect, a method for wireless communication includes: decoding resource configuration data specifying a channel state information (CSI) reference signal (RS) resource configuration for performing one or more channel measurements for calibrating one or more transmissions from one or more transmission reception points (TRPs); and encoding, based on the CSI-RS resource configuration specified by the resource configuration data, a CSI report including measurement data for transmitting to the one or more TRPs for calibration of the one or more TRPs for a coherent joint transmission (CJTs).

In some implementations, the method includes decoding a CJT received from the one or more TRPs that are calibrated based on the measurement data.

In some implementations, the coherent joint transmission supports up to four TRPs or TRP groups.

In some implementations, resource configuration data specifies channel measurement resource (CMR) configurations for reporting a time offset, a frequency offset, or a phase offset for each of the one or more TRPs.

In some implementations, the resource configuration data specifies channel measurement resources in a single CSI-RS resource set for the CSI report, wherein each CSI-RS resource for the one or more TRPs is a part of the single CSI-RS resource set.

In some implementations, the resource configuration data specifies channel measurement resources in a plurality of CSI-RS resource sets for the CSI report, wherein each CSI-RS resource set is configured for a corresponding one of the one or more TRPs, and wherein each CSI-RS resource set is configured as a tracking reference signal (TRS) resource set.

In some implementations, the method comprises encoding, in the UE capability report, a maximum number of different quasi-co-locations sources supported for CSI report for calibration of the one or more TRPs for a coherent joint transmission (CJTs).

In some implementations, the resource configuration data specifies that each TRS resource set of the CSI-RS configuration includes a same number of CSI-RS resources per TRS resource set as each other configured TRS resource set.

In some implementations, the resource configuration data specifies that each TRS resource set of the CSI-RS configuration includes a single slot, each slot comprising two CSI-RS resources. In some implementations, the resource configuration data specifies that each TRS resource set of the CSI-RS configuration includes two slots, each slot comprising two CSI-RS resources. In some implementations, the two slots are consecutive slots.

In some implementations, the resource configuration data specifies that each TRS resource set of the CSI-RS configuration has a periodic timing domain behavior.

In some implementations, the resource configuration data specifies that each TRS resource set of the CSI-RS configuration has an aperiodic timing domain behavior.

In some implementations, the resource configuration data specifies that each TRS resource set of the CSI-RS configuration includes a same frequency bandwidth as each other TRS resource set.

In some implementations, the resource configuration data specifies that each TRS resource set of the CSI-RS configuration includes a same number of physical resource blocks (PRBs) as each other configured TRS resource set.

In some implementations, the resource configuration data specifies, for each TRS resource set of the CSI-RS configuration, a same starting physical resource block (PRB) index as for each other configured TRS resource set.

In some implementations, the resource configuration data specifies, for each TRS resource set of the CSI-RS configuration, a same set of resource elements (REs) in a frequency domain within a PRB as for each other configured TRS resource set.

In some implementations, the resource configuration data specifies, for each TRS resource set of the CSI-RS configuration, a different set of resource elements (REs) in a frequency domain within a PRB, the different resource set different from each other configured TRS resource set.

In some implementations, the method includes encoding a first TRS resource set to be transmitted on a same symbol as a second TRS resource set, the first TRS resource set using a first set of REs in the symbol, and the second TRS resource set using a second set of REs in the symbol.

In some implementations, the resource configuration data specifies that each CSI-RS resource set includes a same number of CSI-RS resources per TRS resource set as each other configured TRS resource set.

In some implementations, the resource configuration data specifies that each CSI-RS resource set includes a single slot, each slot comprising two CSI-RS resources. In some implementations, the resource configuration data specifies that each CSI-RS resource set includes two slots, each slot comprising two CSI-RS resources. In some implementations, the two slots are consecutive slots.

In some implementations, the resource configuration data specifies that each CSI-RS resource set has a periodic timing domain behavior. In some implementations, the resource configuration data specifies that each CSI-RS resource set has an aperiodic timing domain behavior.

In some implementations, an aperiodic CSI resource set is configured to span more than one slot. In some implementations, each CSI resource of a single CSI-RS resource set is associated with a respective slot offset value. In some implementations, different CSI-RS resources in the single CSI-RS set are located in different slots, based on the respective slot offset values.

In some implementations, the resource configuration data specifies that each CSI-RS resource set has a semi-persistent timing domain behavior.

In some implementations, the resource configuration data specifies that each CSI-RS resource set includes a same frequency bandwidth as each other CSI-RS resource set.

In some implementations, the resource configuration data specifies that each CSI-RS resource set includes a same number of physical resource blocks (PRBs) as each other configured CSI-RS resource set. In some implementations, the resource configuration data specifies, for each CSI-RS resource set, a same starting physical resource block (PRB) index as for each other configured CSI-RS resource set.

In some implementations, the resource configuration data specifies, for each CSI-RS resource set, a same set of resource elements (REs) in a frequency domain within a PRB as for each other configured CSI-RS resource set. In some implementations, the resource configuration data specifies, for each CSI-RS resource set, a different set of resource elements (REs) in a frequency domain within a PRB, the different resource set different from each other configured CSI-RS resource set.

In some implementations, the operations include encoding a first CSI-RS resource set to be transmitted on a same symbol as a second TRS resource set, the first CSI-RS resource set using a first set of REs in the symbol, and the second CSI-RS resource set using a second set of REs in the symbol.

In some implementations, the operations include decoding a configuration for the CSI report, the CSI report specifying a timing offset, a frequency offset, a phase offset, or a combination of any of the timing offset, the frequency offset, and the phase offset.

In some implementations, the configuration of the CSI report specifies a timing unit for reporting the timing offset. In some implementations, the timing unit is based on a cyclic prefix duration. In some implementations, the timing unit is based on an inverse of a sub-carrier spacing of a measurement resource used for performing a measurement of the timing offset. In some implementations, the timing unit is based on a symbol duration. In some implementations, the symbol duration is based on an inverse of a sub-carrier spacing and cyclic prefix value of a measurement resource. In some implementations, the symbol duration is based on an average value of the symbol duration in a slot.

In some implementations, the configuration of the CSI report specifies a frequency unit for reporting the frequency offset. In some implementations, the frequency unit is based on a sub-carrier spacing of a measurement resource. In some implementations, the frequency unit is based on a parts per million (ppm) of a carrier frequency.

In some implementations, the configuration of the CSI report specifies a phase offset reporting configuration for reporting the phase offset. In some implementations, the phase offset reporting configuration supports a wideband phase report only. In some implementations, the phase offset reporting configuration supports both a wideband phase report and a set of sub-band phase reports. In some implementations, a size of each sub-band for the sub-band phase reports is based on a channel quality indicator (CQI) sub-band size. In some implementations, a size of each sub-band for the sub-band phase reports is based on a pre-coding matrix indicator (PMI) sub-band size. In some implementations, a size of each sub-band for the sub-band phase reports is based on a bandwidth part (BWP) of the measurement signal or a bandwidth of a channel measurement resource including a CSI-RS. In some implementations, the phase offset reporting configuration specifies that each sub-band phase offset is reported independently to the TRP. In some implementations, the phase offset reporting configuration specifies that a reference phase offset and phase offset step size are reported to the TRP.

In some implementations, the configuration of the CSI report specifies that at least two offsets selected from a group consisting of a phase offset, a timing offset, and a frequency offset are reported in a same CSI report.

In some implementations, the configuration of the CSI report specifies that, when a phase offset is not being reported, a timing offset and a frequency offset are reported in a same TRS resource set.

In some implementations, the configuration of the CSI report specifies that, when a phase offset is being reported with a time offset or a frequency offset, the phase offset is reported in the same TRS resource set as the time offset or the frequency offset.

In some implementations, the configuration of the CSI report specifies that, when a phase offset is being reported with a time offset or a frequency offset, the phase offset is reported in a CSI resource independent of a TRS resource set used for reporting the time offset or the frequency offset.

In some implementations, the configuration of the CSI report specifies that a UE is allowed to select any TRP as a reference TRP, and wherein, for each offset report, the reference TRP offset is independently reported.

In some implementations, the configuration of the CSI report specifies a priority for simultaneous offset reports when a payload size of the offset reports exceeds a size allocated for uplink payload. In some implementations, the priority is fixed. In some implementations, the priority is configured in the CSI report.

In some implementations, the configuration of the CSI report specifies that all simultaneous offset reports are omitted when an uplink payload is not large enough to carry all of the simultaneous offset reports together.

In some implementations, a CSI-RS resource is configured as a channel measurement resource, and wherein a CSI process unit (CPU) count is associated with a UE capability. In some implementations, each configured CSI-RS resource is counted as 1 CPU for UE capability reporting.

In some implementations, all configured CSI-RS resources are together counted as 1 CPU for UE capability reporting. In some implementations, the CPU count is decoded as the UE capability. In some implementations, the CPU count is based on a number of TRPs.

In some implementations, a TRS resource set is configured as a channel measurement resource, and wherein a CSI process unit (CPU) count is associated with a UE capability. In some implementations, each configured TRS resource set is counted as 1 CPU for UE capability reporting. In some implementations, the CPU count is based on a number CSI-RS resources. In some implementations, all configured TRS resource sets are together counted as 1 CPU for UE capability reporting. In some implementations, the CPU count is decoded as the UE capability. In some implementations, the CPU count is based on a number of TRPs.

In some implementations, multiple offsets are configured for being reported in the CSI report, and wherein a CPU count of each offset is determined independently for a total CPU count.

In some implementations, multiple offsets are configured for being reported in the CSI report, and wherein a CPU count of each offset is determined jointly for a total CPU count.

In an aspect, a system comprises one or more computers and one or more storage devices on which are stored instructions that are operable, when executed by the one or more computers, to cause the one or more computers to perform operations of the foregoing methods or operations. In an aspect, a system comprises one or more computers and one or more storage devices on which are stored instructions that are operable, when executed by the one or more computers, to cause the one or more computers to perform operations of the foregoing operations. In an aspect, a non-transitory computer storage medium is encoded with instructions that, when executed by one or more computers, cause the one or more computers to perform operations of the method of any of foregoing operations. In an aspect, an apparatus comprises one or more baseband processors configured to perform operations of the method of any of the foregoing operations.

In an aspect, an apparatus or user equipment includes one or more processors configured for wireless communication to perform operations of any of the preceding methods.

In an aspect, one or more processors are configured to perform operations for wireless communication of any of the preceding methods.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates an example system with multiple transmission-reception points (TRPs).

FIG. 3 illustrates a flowchart of an example method, according to some implementations.

FIG. 4 illustrates an example user equipment (UE), according to some implementations.

FIG. 5 illustrates an example access node, according to some implementations.

### DETAILED DESCRIPTION

This document describes a design for CSI enhancement for OTA (Over The Air) multi-TRP calibration. The network can specify configurations to the UE for performing measurements of reference signals received from transmission/reception points (TRPs) in the network. The UE measures offsets for timing, frequency, and phase from the reference signals of each TRP. The UE sends the measurements back to the TRPs to assist the TRPs for calibration for coherent joint transmission (CJT). The configuration specifies, for the UE channel measurement resources. The configuration specifies how the UE should report each offset, which can include independent measurement reports for each offset. The configuration specifies how the UE should report each offset, which can include joint measurement reports for each offset. The network can configure how the UE should specify its reporting capability, such as in terms of channel state information (CSI) processing units (CPUs). This is called the UE processing requirement.

Generally, the UE assists in calibrating the TRPs for coherent transmission. Coherency means that the TRPs transmit with the same time domain, frequency domain, and phase characteristics to the UE. Each TRP channel has its own phase for multi TRP. Different TRPs can perform transmission coherently to align their phases. If the TRP can compensate for the phase, it improves MIMO performance. For the TRPs to compensate for phase offsets, the transmitters maintain coherency. Specifically, a phase measured at time A should still be captured at time B. There is also a requirement for TRP to have synchronization in time and frequency domain. Different TRPs have high fidelity for phase calibration. However, calibration is not perfect in practice. The TRPs have some offsets in frequency, time, and phase. different calibrations for DL and UL, which can impact CJT performance negatively.

To solve this, the network specifies CSI reporting enhancements to allow network to correct for offsets in frequency, time, or phase. Generally, for any CSI measurement, network specifies a measurement resource configuration. The report supports 3 different reports including a phase offset report, a frequency offset report, and a timing offset report. These reports can be independent in design, as subsequently described. In an example, for each report, there is only 1 offset reported. In another example, there are joint reports that include multiple offsets in the same report.

In another embodiment, the network specifies how to share measurement resources to perform the CSI transmission. In an example, if the uplink payload size is not large enough the network can specify how the UE can omit the CSI to fit into the payload. The network also specifies calculations needed for UE processing ability for aperiodic reporting.

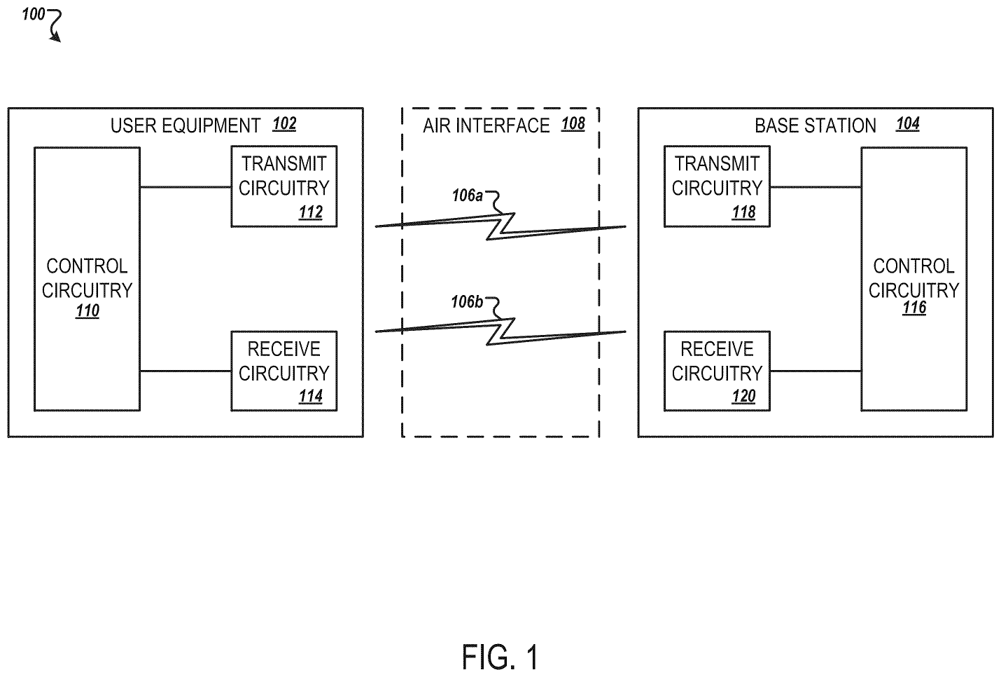

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can decode configuration data to configure measurement resources for measuring offset values from each of the TRPs to assist the TRPs for calibration for CJT.

The transmit circuitry 112 can perform various operations described in this specification. For example, the transmit circuitry 112 can send data to TRPs reporting offset values for calibration of the TRPs for CJTs. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 can receive transmissions from transmission/reception points for coherent joint transmissions. The receive circuitry can receive configuration data specifying how to calibrate the TRPs. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, an LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

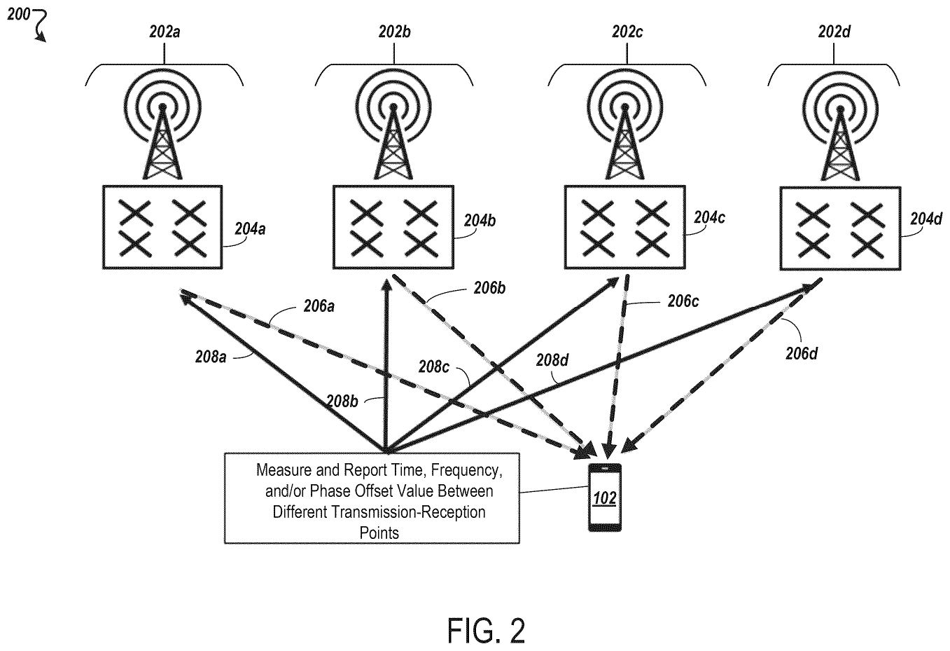

FIG. 2 illustrates an example system 200 with multiple transmission-reception points (TRPs) 202a-d. Each TRP 202a-d is configured to communicate with the UE 102. The UE is configured to receive transmissions 206a-d from the respective TRPs 202a-d and measure offsets in the time domain, frequency domain, and the phase from among the transmissions 206a-d. The UE 102 measures the offsets and reports the offset measurements in respective transmissions 208a-d to assist in calibrating the TRPs for coherent joint transmission.

In some implementations, there are up to four TRPs 202a-d or TRP groups. Generally, the UE 10w reports offsets that include the offsets between each TRP transmission 206a-d. In some implementations, the TRPs are non-co-located, or specifically, the TRPs 202a-d are in different places and at different distances with respect to the UE 102.

In some implementations, each TRP 202a-d has a respective antenna array 204a-d. In FIG. 2, eight antennae are shown per TRP 202a-d, but the number of antennae in the array can be dozens or hundreds. The UE 102 measures the reference signal (RS) 206a-d from each TRP 202a-d. In some implementations, the UE measures a timing offset, a frequency offset, and/or a phase offset of the RSs and reports offset values back to TRPs 202a-d using transmissions 208a-d. Each TRP 202a-d performs a calibration/correction based on received offset values to remove or correct for the offsets to perform coherent transmissions.

The transmissions 206a-d are measurement reference signals transmitted from each TRP 202a-d. These are channel measurement resources (CMR). The CMRs can be configured within the same RE (resource element) in the CSI report configuration. It is the smallest unit of the resource grid made up of one subcarrier in frequency domain and one OFDM symbol in time domain. The CSI-ReportConfig represents a configuration of the CSI. Within the CSI configuration, there is a CMR configuration. This traditionally covers 1 TRP. For multiple TPRs 202a-d, the number of REs can be increased for channel measurement. In some implementations, for up to 4 TRP, up to 4 measurement resources are configured. In some implementations, these measurement resources are configured by the network using a same information element (IE). The resources for the channel measurement IE are a linkage for the resource configuration. Within the same resource configuration the network configures measurements by the UE 102 for all the TRPs 202a-d. When the CSI-ReportConfig links to a particular CSI-ResourceConfig, only a single IE is needed (a resources for channel measurement IE), which simplifies the CSI report.

Generally, the network can configure more than one resource set. In a particular CSI resource configuration, the network can determine whether to use multiple resource sets to map to different TRPs 20a-d or use the same resource set for all the TRPs. In some implementations, if using the same resource set, the network specifies different resources to map to the different TRPs

In an example, the network configures a single CSI-RS resource set. The network configures a same number of resources as the number of TRPs. For example, 4 resources are configured for 4 TRPs 202a-d. In some implementations, all resources are within the same set. This is useful for the phase measurement, which uses only 1 CSI-RS resource to measure the phase (for each TRP). All four resources can be included in the same CSI-RS resource set. This approach is optimized for phase offset measurements but can be used for frequency and timing offset measurements as well.

In some implementations, a single CSI-RS resource set is not always the best option. The frequency offset can require multiple (two or four) CSI-RS resources for each offset determination. UE measures the phase difference between the two signals at two different times. Based on the phase difference divided by the time difference, the UE calculates the frequency offset. the pair of signals/measurements is called the TRS-tracking reference signal (defined as a resource set).

In some implementations, for frequency offset measurements, the network specifies a different set for each TRP. Each set is called a tracking reference signal (TRS) resource set. The network uses different CSI-RS resource set for each TRP 202a-d, each including multiple resources. Each set can be for a respective TRS. A maximum number of sets is 4 (e.g., the maximum number of TRPs). This approach is optimized for frequency offset measurements but can be used for phase or timing offsets as well. Generally, it is efficient to use 1 resource if it is enough for the measurement (phase). Else, it is efficient to use resource sets for measurements that require multiple measurements.

In some implementations, before the UE 102 performs measurements, the UE assumes a quasi-co-location (QCL) source. Two antenna ports are said to be quasi co-located if properties of the channel over which a symbol on one antenna port is conveyed can be inferred from the channel over which a symbol on the other antenna port is conveyed. QCL helps the UE 102 determine the channel high order statistics. Each resource can be configured with QCL source to inform UE how to measurement the resource, such as channel higher order statistics. The network can require that all the different resources share a same QCL source to reduce UE processing complexity.

Typically, different TRPs have a high level of commonality in the channel properties in their respective transmissions. otherwise the QCL is inefficient for coherent transmission (e.g., major adjustments are needed to one or more TRP transmissions, and these large corrections induce transmission inefficiencies over all of the TRPs).

There is a benefit to limit the number of CRI-RS resources (e.g., across 4 TRPs) that different QCL sources. In other words, when multiple CSI-RS resources share the same QCL source, it is easier for UE to process those CSI-RS resources as they share similar channel properties. A simplest way for UE to handle coherency is to assume that, even though there are 4 TRPs with different CMRs, the QCL source is the same across all four TRPs, and that they have the same channel properties. This simplifies the UE measurement but may not comport with the actual channel properties for the TRPs because the channel properties can be different for each of the up to four TRPs. Therefore, the number of QCL sources can be between 1 and 4 for 4 TRPs. The larger the number of possible QCL sources, the more difficult it is for the UE to support measurements. Thus, the UE 102 can control the capacity of the number of QCL sources to simplify measurement.

In some implementations, the network assumes that the TRS is being used for the measurement (resource set). This is best for frequency and timing offset, but can be used for phase measurements, too. One TRS can be used for each CMR. In some implementations, the network configures multiple TRS resource sets for multiple TRPs. There are some restrictions to ensure that the different resource sets have similar patterns to one another, such as in the time and frequency domains.

The UE eventually has to measure all of the different TRS resource sets to determine the offset (e.g., the frequency, timing, or phase offset). It is easier for the UE to measure the different TRS resource sets when the TRS resource sets have as much commonality in the frequency and time domain as possible. The restrictions ensure that the network does not randomly configure TRS resource sets for the UE to perform measurements. Rather, the configured TRS resource sets have commonality as described below.

The first restriction is how many CSI-RS resources are available in each TRS resource set. This is because the TRS resource set can have one of two configurations. The first example configuration includes a single slot TRS resource set with two CSI-RS resources in the slot. The second example configuration is a TRS resource set that includes two slots. For this configuration, the TRS resource set includes two consecutive slots. Each of the slots has two CSI-RS resources per slot for a total of four CSI-RS resources available in the TRS resource set.

The network (e.g., the gNB) generally configures the same number of slots for different TRS resource sets in the group of TRPs. For example, each of the TRPs in the set of TRPs transmits the TRS resources with one slot (single slot TRS), or each of the TRPs in the set of TRPs transmits the TRS resources with two slots (two slot TRS). This enables the UE to make the measurement comparable across different TRPs for different TRS resource sets.

The network (e.g., the gNB) generally configures each of the TRS resource sets for each TRP to have a same time domain behavior as the other TRS resource sets for other TRPs. Specifically, each of the TRS resource sets is configured to be periodic, or each of the TRS resource sets is configured to be aperiodic. Specifically, the network configures all the TRPs to use either aperiodic time domain behavior for each TRS resource set or periodic time domain behavior for each TRS resource set. The common use of periodic or aperiodic behavior for the TRS resource sets simplifies the UE measurement.

Generally, most TRS resource sets for a TRP are periodic. In some implementations, the network may allow periodic TRS resource sets only and prohibit the TRPs from using aperiodic resource sets. When periodic TRS resource sets are used, each TRP uses a same periodicity.

The network can configure each of the TRPs to use TRS resource sets having consistent frequency resources in the frequency domain. Specifically, the network can configure each of the TRPs to use a same bandwidth in the frequency domain for the respective TRS resource sets of each TRP. For example, each TRS resource set can specify 50 physical resource blocks (PRBs). In another example, each TRS resource set can specify 60 PRBs. Regardless of the number of PRBs, the network can configure the bandwidth size to be consistent for each of the TRS resource sets. Different bandwidths for the TRS resource sets can result in different accuracies for the UE measurements, which results in inconsistency in the offset calculation and a lack of coherent transmission by the TRPs.

The network can configure each of the TRS resource sets to have a same location of resources in the frequency domain. For example, the network can configure the TRS resource sets to use the same physical resource blocks (PRBs) for each TRP. The TRS resource sets can use the same PRBs as other TRS resource sets. Specifically, the network can configure a starting PRB for the TRS resource sets. When combined with the requirement for a same bandwidth for each TRS resource set for different TRPs, the network enforces a requirement for use of the same frequency resources (e.g., PRB set).

Additionally, within each of the PRBs, the network can enforce a requirement of which resource elements (REs) should be part of each TRS resource set. In an example, the network can specify that each TRS resource set occupies a same set of REs in the frequency domain within the PRBs. In this example, the measurement by the UE is simplified as the same REs are used for each transmission from the TRPs. For example, the TRS resource set can occupy the first two REs, the third and fourth REs, or some other combination of REs. In another example, the network can specify that each TRS resource set occupies a different set of REs in the frequency domain within the PRBs. In this example, the TRP can transmit multiple TRS resource sets in a same symbol, such as at the same time, using the different sets of REs specified by the network. The TRS resource sets can therefore occupy a smaller span in the time domain (e.g., a single symbol) rather than using multiple symbols for the TRS resource sets. The TRS resource sets can therefore be transmitted at the same time, reducing a time overhead for the UE to perform measurements for each of the TRPs in the TRP set.

The network can enforce similar restrictions in examples in which a single CSI-RS resource set is used rather than a TRS resource set. For example, as previously described, the network may configure a single CSI-RS resource as a CMR for different TRPs. The single CSI-RS resource is designated for the UE for measuring the phase offset for the different TRPs because the UE does not require a differential signal to perform these measurements. Use of a single CSI-RS resource set can reduce signaling overhead for performing offset measurements by the UE. The network can enforce restrictions for the single CSI-RS resource set using a similar set of constraints as are used for the TRS resource sets previously described.

The network can configure each of the CSI-RS resources for each TRP to have a same time domain behavior as the other CSI-RS resources for other TRPs. Specifically, each of the TRS resource sets is configured to be periodic, semi-persistent, or aperiodic. A semi-persistent resource includes a periodic resource that can be activated/deactivated by a MAC-CE. A regular periodic resource is configured/released by the network using radio resource control (RRC). A semi-persistent resource allows the network to use a MAC-CE to activate/deactivate resource. Once activated, a semi-persistent resource is periodic.

Specifically, the network configures all the TRPs to use either aperiodic time domain behavior for CSI-RS resources, a semi-persistent time domain behavior for CSI-RS resources, or periodic time domain behavior for CSI-RS resources. When periodic or semi-persistent CSI-RS resources are specified by the network, each TRP uses a same periodicity for the CSI-RS resources as each other TRP. The common use of periodic, semi-persistent, or aperiodic behavior for the CSI-RS resources simplifies the UE measurement (e.g., for the time or phase offset measurements).

Generally, most CSI-RS resources from a TRP are periodic. In some implementations, the network may allow periodic CSI-RS resources only and prohibit the TRPs from using aperiodic TRS resource sets or semi-persistent CSI-RS resources.

The network can configure each of the TRPs to use CSI-RS resources sets having consistent frequency resources in the frequency domain. Specifically, the network can configure each of the TRPs to use a same bandwidth in the frequency domain for the respective CSI-RS resources of each TRP. For example, each of the CSI-RS resources can specify 50 PRBs. In another example, each TRS resource set can specify 60 PRBs. Regardless of the number of PRBs specified, the network can configure the bandwidth size to be consistent for each of the CSI-RS resources from different TRPs. Different bandwidths for the CSI-RS resources can result in different accuracies for the UE measurements, which results in inconsistency in the offset calculation and a lack of coherent transmission by the TRPs.

The network can configure each of the CSI-RS resources to have a same location of resources in the frequency domain. For example, the network can configure the CSI-RS resource sets to use the same RBs for each TRP. The CSI-RS resources can use the same PRBs as other CSI-RS resources. Specifically, the network can configure a starting PRB for the CSI-RS resources. When combined with the requirement for a same bandwidth for each CSI-RS resource for different TRPs, the network enforces a requirement for use of the same frequency resources (e.g., a same PRB set).

Additionally, within each of the PRBs, the network can enforce a requirement of which REs should be part of each CSI-RS resource. In an example, the network can specify that each CSI-RS resource occupies a same set of REs in the frequency domain within the PRBs. In this example, the measurement by the UE is simplified as the same REs are used for each transmission from the TRPs. For example, the CSI-RS resource can occupy the first two REs, the third and fourth REs, or some other combination of REs. In another example, the network can specify that each CSI-RS resource occupies a different set of REs in the frequency domain within the PRBs. In this example, the TRP can transmit multiple CSI-RS resources in a same symbol, such as at the same time, using the different sets of REs specified by the network. The CSI-RS resources can therefore occupy a smaller span in the time domain (e.g., a single symbol) rather than using multiple symbols for the CSI-RS resources. The CSI-RS resources can therefore be transmitted from the TRPs at the same time, reducing a time overhead for the UE to perform measurements for each of the TRPs in the TRP set.

The network may specify that all the transmissions for an aperiodic CSI-RS are to be transmitted within a single slot. In some implementations, when there four TRPs, each of the CSI-RS transmissions would be transmitted using a single symbol, and therefore four symbols would be included in a single slot. In some slot formats, four symbols can fit into a single slot, as each slot provides 14 available symbols. However, in other slot formats, not all four symbols can fit within the single slot if a limited number of slots are available. The number of available symbols can be less than 4 in a time division duplex (TDD) system, where the DL and the UL share a same spectrum. There may not be enough DL symbols available if there are too many UL symbols configured. When fewer symbols are available than requested for the given number of TRPs (e.g., 1, 2, 3, or 4), the network configures the TRP measurement resource sets to allow a single aperiodic CSI-RS resource set to span (e.g., occupy) more than 1 slot. For example, if four resources are requested for the same aperiodic CSI-RS resource set, the network permits the four resources to be located across more than one slot.

The network can configure the aperiodic CSI-RS resource set to span multiple slots as follows. In a first example, for each CSI-RS resource in the aperiodic CSI-RS resource set, the network can configure a respective slot offset. The network therefore can allow different CSI-RS resources to be located in different slots, based on the respective slot offsets, for a single CSI-RS resource set. In another example, the network sends configuration data to the UE for the entire CSI-RS resource set. Specifically, the network configures a single CSI-RS resource in the CSI-RS set. The remaining CSI-RS resources are associated with slot offsets (timing offsets) with respect to the first offset value. For example, each subsequent CSI-RS resource can be configured for a symbol gap from the first offset value (e.g., each 4^{th} symbol, each 8^{th} symbol, etc.). Therefore, each CSI-RS resource of the set is associated with a fixed time domain gap with respect to the other CSI-RS resources of the set. The symbol offset of the configuration specifies the gap between each CSI-RS resources. The network specifies a location for the first CSI-RS resource, and each subsequent CSI-RS resource is at a fixed timing offset with respect to that first CSI-RS resource to occupy more than one slot.

The channel measurement resource configuration by the network described allows for different resources or resource sets for each of the TRPs. The UE can measure the transmissions by the respective TRPs accurately and report the offsets for calibrating the TRPs for coherent joint transmission. As described herein, the particular resources configured by the network can be selected based on which offset (e.g., time, frequency, phase, etc.) is being measured for the calibration of the joint transmission. The network generally specifies that common resources are to be used by the TRPs for channel measurement signals sent to the UE to simplify measurement by the UE, whether the network is configuring TRS resource sets or CSI-RS resources for channel measurement.

The network can configure the UE to generate an independent report for channel measurement for each of the TRPs of the set of TRPs. The network can configure the UE to send different offset reports having different configurations for different TRPs.

The network configures the UE to report the timing offset with a given unit and a given range. The report can include values between and including a minimum value and a maximum value. The network can specify a uniform composition of the timing offset reports. For example, if 5 bits are allocated to the timing offset report, there are 32 possible reports. Given that there is a uniform composition and a minimum and maximum value, for each codepoint, the TRP is configured to map the bit values to represent timing offset values.

The timing unit for the timing offset report is now described. Generally, the network specifies a single unit configuration for the TRPs of the TRP set. The single unit can be defined in a one of the following ways. The timing single unit can be defined based on the duration of the cyclic prefix (CP). The CP can have a fixed duration. For example, a baseline numerology for subcarrier spacing (SCS) is 15 kilohertz (kHz). For 15 kHz SCS, the CP duration is 144 samples with a sampling rate of 30.72 megahertz (MHz). Specifically, the CP absolute duration is 4.69 microseconds. The baseline numerology has a possibility of 2^{k} scalability (e. g., supporting 30 kHz, 60 kHz, 120 kHz, 240 kHz, 480 kHz, 960 kHz . . . ). The UE can report the timing offset using the CP duration as a unit. For example, a timing offset of 1 CP between transmissions from two TRPs is 4.69 μs.

The timing single unit can be defined based on an inverse value of the SCS. For example, if the baseline SCS is 15 kHz, the duration of the orthogonal frequency-division multiplexing (OFDM) symbol without a CP is 66.67 microseconds.

The timing single unit can be defined based on a symbol duration. The symbol duration includes the inverse of the SCS timing in addition to the CP duration. For example, for a 15 kHz SCS, the OFDM symbol duration is 66.67 microseconds from the inverse SCS and 4.69 microseconds from the CP duration for a total of 71.36 microseconds. In another example, the network can assume that each symbol in a slot has an equal duration (e.g., 1/14^{th} of the slot length). For a 1 millisecond slot length, each symbol length averages to 71.43 microseconds. However, in some examples, the CP duration can vary for different symbols to result in a rational number for the symbol length. Therefore, some symbols have a slightly longer CP than others (e.g., at the beginning and middle of the slot), and the exact length of each symbol is not necessarily identical, accounting for the discrepancy between the value obtained using an average symbol length and a value obtained using the inverse SCS and CP. The SCS is determined by using 2^{k}*15 kHz, wherein the time unit is scaled by 2^{-k}. The unit is based on the numerology specified based on the measurement resource rather than based on another signal such as the SCS of the signal for triggering the CSI or the SCS for sending the report from the UE. The stated numerology is used by the TRP to translate from the reported timing offset value from the UE to the actual timing offset value for a given TRP.

The network configures the UE to report the frequency offset with a given unit and a given range. The report can include values between and including a minimum value and a maximum value. The network can specify a uniform composition of the frequency offset reports. For example, if 5 bits are allocated to the frequency offset report, there are 32 possible reports. Given that there is a uniform composition and a minimum and maximum value, for each codepoint, the TRP is configured to map the bit values to represent frequency offset values.

The different definitions of the single frequency unit are now described. Similar to the timing offset report, the network specifies a single unit for reporting the frequency offset for all the TRPs. In a first example, the SCS of the measurement resource represents a unit for the frequency offset. If the SCS is 15 kHz, for example, a unit of 0.1, the frequency offset is 1.5 kHz. In a second example, the UE reports the frequency offset based on parts per million (ppm) with respect to the carrier frequency (e.g., f_{c}). The ppm helps quantify the offset for different frequencies even when the values scale to high numbers. This is because the frequency offset is likely to be greater at greater frequencies. For example, if the offset value reported is 0.1 ppm of the carrier frequency at 2.5 gigahertz (GHz), the frequency offset is 0.25 kHz.

The network configures the UE to report the phase offset between TRPs using wideband or sub-band reporting. The different definitions of the single phase unit are now described. For the phase offset, the network can specify that the phase offset is reported by the UE using the wideband phase offset. In some implementations, the offset measurement is performed using a wideband signal. Generally, the wideband reporting is supported. The network can then specify whether sub-band reporting is supported.

In new radio platforms, there is up to 100 MHz on the downlink (DL) in frequency range 1 (FR1). In some implementations, when the 100 MHz channel is measured, the phase offset is reported based on dividing the channel into sub-bands and reporting the different phase offsets for the respective sub-bands. The sub-band reporting assumes that, for different sub-bands, respective different phase offset measurements are being reported by the UE. The different phase offsets at different sub-bands can occur for several reasons. For example, the base station node (gNB) calibration error is different for different sub-bands. In another example, there is a timing error that translates to different phase offsets for different sub-band frequencies.

To enable the UE to perform sub-band reporting, the network defines the sub-band sizes. The network can define the sub-band size based on the following examples. In a first example, the sub-band size is the same as the channel quality indicator (CQI) sub-band size. The CQI signal sub-band size is known to the network. In another example, the sub-band is the same as the pre-coding matrix indicator (PMI) sub-band size. In another example, the sub-band size is independently configured. In this example, the sub-band size is a function of the bandwidth part (BWP) of the channel measurement resource. This can reduce the number of sub-bands for large frequencies. For example, if the bandwidth of the channel is large, the sub-bands are made larger relative to the smaller sub-bands when the channel bandwidth is smaller.

When the network configures the UE for reporting the phase offset based on sub-band reporting, reporting can be configured as now described. The sub-band reporting can be performed by reporting the phase offset for each sub-band using independent encoding for each sub-band. For example, for 10 different sub-bands, the UE reports 10 different phase offsets independently. Independent reporting for each sub-band is highly flexible but costs relatively more overhead than reporting using a reference TRP.

In another example, the phase offset for a first sub-band is reported independently, and the phase offsets for the other sub-bands are reported relative to the first sub-band phase offset. When the phase offset is caused by a timing error, the delay in the time domain causes phase offsets in the frequency domain than ramp up according to a linear function. Rather than report each sub-band phase offset independently, the network can configure the UE to report the phase step size (e.g., the slope of the linear function) to represent the respective phase offsets for each of the sub-bands. The phase step size is reported, for the i^{th} sub-band, as θᵢ=θ₀+i* δ, where θ₀, is the phase offset reported for the first sub-band, and δ is the reported phase step size. This equation applies when there is a constant time offset in the time domain. Based on this relationship, the network (gNB) can determine the phase offset for each sub-band based on reporting a reference sub-band phase offset by the UE.

The network may configure the UE to perform joint reporting of different offsets including the time offset between TRPs, the frequency offset between TRPs, and the phase offset between TRPs. In some implementations, the network can configure the UE to report each of these offsets individually. In some implementations, the network allows the UE to report two or all of the measure offsets in a joint report. The joint report can enable the UE to reduce signaling overhead with the TRPs in addition to saving time for configuring the TRPs for coherent transmission. The plurality of offsets, selected from the group of time offsets, frequency offsets, or phase offsets, can be indicated by the network (e.g., the gNB) to the UE to occur in a same CSI report. Instead of sending two or three reports, the UE can send a single report.

For each CSI report, the network specifies a measurement resource. The network can specify a CMR configuration for the report. When the network configures multiple offset reports to occur simultaneously in the same CSI report, the network can simplify the CMR configuration relative to the configurations of each offset being measured and reported individually. For example, both the reports can share the same reporting resources. For frequency offset reporting, the TRS resource set is prioritized because the frequency offset calculation is based on use of a differential signal. Similarly, for the timing offset, the TRS resource set is prioritized. For the phase offset reporting, the CSI report is prioritized. Because the CSI is prioritized for reporting phase offsets separately (e.g., without timing or frequency offset reporting), the same TRS resource set can be used for each TRP for the time and frequency offset reporting in a single CMR configuration.

When the phase offset is being reported together with either the frequency or the time offset, the network can configure the UE to report based on the following examples. In a first example, because the UE is already sending a TRS resource set, the UE can include the phase offset in the TRS resource set for reporting. The UE does not need to reconfigure a CSI resource for the phase offset report. In a second example, the network always configures the phase offset with a different CMR configuration than the frequency or time offset reporting. In this example, the phase offset is reported using a CSI resource of a first CMR configuration. The timing offset, frequency offset, or both are always performed using a TRS resource set of a different, second CMR configuration independent of the first CMR configuration.

In some implementations, the network can configure the UE to report more than one offset simultaneously in terms of a reference TRP report. Within the TRP, the UE can perform differential encoding for the timing, frequency, or phase offsets. The UE does not need to report the offset for every TRP. Rather, the UE can be configured by the network to report offsets for the reference TRP. For the remaining TRPs, the UE can report a differential value between the reference TRP, and a given remaining TRP. To select the reference TRP, the UE can be configured as follows. In some implementations, the network allows the UE to select any TRP as the reference TRP. For each offset, reference TRP is independently reported. Specifically, the UE can report any reference TRP independently for time offset, frequency offset, and phase offset. The reference TRP is used for differential encoding.

In some implementations, the UE is configured to jointly report multiple offsets, as previously described. The UE can be configured to report more than one offset simultaneously in terms of uplink control information (UCI)/CSI omission. UCI/CSI omission is for UE to drop/omit some or all the CSI report when the UL payload is not enough to carry all the UCI. In some implementations, the network does not have enough resources to carry the larger payload size of the simultaneous reporting for multiple offsets. The UE is configured to drop some of the payload to fit the reporting into the allocated reporting resources.

A particular offset report or portion thereof can be omitted based on a priority. The priority can be defined per offset. In a first example, the priority can be hard-coded into the specification. For example, the time offset report is associated with a higher priority than the frequency offset report, which in turn is associated with a higher priority than the phase offset report. In another example, the priority is configured as a part of the CSI report. In some implementations, the offset is dropped sequentially from a low priority to a high priority until the remaining offset report data can be carried by the uplink (UL) payload. Each time a report is dropped, the payload size is checked. If the remaining offset reports fit into the UL payload, the remaining offsets are reported.

In some implementations, the offset reports are all dropped simultaneously if any report is to be dropped. For example, the timing offset report can include 100 bits of data, and the phase offset reporting can include 100 bits of data. If the uplink can only carry 150 bits, the UE drops all offset reporting from the message, even though either offset could fit individually in the UL payload size.

The network is configured to determine how may CSI reports the UE can process in accordance with a CSI process unit (CPU) count. The CPU count represents the number of CSI reports that the UE can process for a slot. For example, the UE can report a CPU count of 8 to indicate that the UE can process 8 CSI reports per slot. Each CSI-RS occupies a given number of CPUs as defined in the specification. In an example, if the network configures two CSI reports, a first CSI report might have a CPU count of 6, and a second CSI report might have a count of 4. If the UE reports a CPU count of 8, then the network determines that the configuration exceeds the UE's capability.

The CSI offset reports previously described are associated with CPU counts as now described. In a first example, the CSI-RS is configured as a CMR. In this case, the following CPU counts can be used. In a first option, each configured CSI-RS resource is counted as 1 CPU. In this case, each TRP occupies 1 CPU. In a second option, all the configured CSI-RS resources are counted as 1 CPU in total. This can be useful when the UE can process multiple TRPs together and the UE capability can easily handle any number of TRPs. In a third option, a number of CPUs counted can be reported as UE capability. As a fourth option, a number of CPUs counted can depend on a number of TRPs. For example, the counts can be 1 CPU for 1 or 2 TRPs, (e.g., 1 or 2 CSI-RS resources). For example, the counts can be 2 CPUs for 3 or 4 TRPs, (e.g., 1 or 2 CSI-RS resources). In the latter case, the number of CPUs does not increase linearly with the number of TRPs but increases at double the rate when there are 3 or 4 TRPs.

In a second example, the TRS resource set is configured as a CMR. When the TRS resource set is configured as the CMR, the following counts can be used. In a first option, each configured TRS resource set is counted as 1 CPU. In a second option, each configured TRS resource set is counted depending on the number of CSI-RS resources. For example, when a TRS resource set is configured with 2 CSI-RS resources, the TRS resource set is counted as 1 or 2 CPUs. For example, when the TRS resource set is configured with 4 CSI-RS resources, the TRS resource set is counted as 2 or 4 CPUs. In a third option, all of the configured TRS resource sets are counted as 1 CPU in total. In a fourth option, a number of CPUs counted can be reported as the UE capability. In a fifth option, the number of CPUs counted depends on a number of TRPs.

In some implementations, multiple offsets are reported in a same CSI, as described previously. In this example, the CPU count can be based on the individual offset reports or based on the total number of combined CSI reports. In a first option, the CPU of each offset can be counted independently. For example, when both the frequency offset and the time offset are configured in a same CSI report, the total CPU is counted as the summation of CPU for frequency offset reporting and the CPU count for the time offset reporting. In this example, when a timing offset CPU count is 4, and a frequency offset CPU count is 4, the total CPU count capability for UE reporting is 8.

In a second option, the CPUs of different offsets are counted jointly. Specifically, when different offsets share a same CMR, the CPU is only counted for one offset. For example, when both a frequency offset and a time offset are configured in the same CSI report and they share a same TRS resource set as the CMR, only a CPU for the frequency offset is counted. In this example, when a timing offset CPU count is 4, and a frequency offset CPU count is 4, the total CPU count capability for UE reporting is 4.

In some implementations, for a CSI report of time, frequency, or phase offsets between different TRPs, in terms of the active CSI-RS resource and port counting, the CPU count can be performed as in the examples described previously.

Generally, when the network triggers a CSI Report request, the UE is not able to compute the result and report right away. Rather, the UE needs a certain amount of time Z or Z′ to perform the measurement and calculate the result. Specifically, Z′ represents a minimum time between the resource and the report. If Z′ is 10 symbols, before the UE can report, the UE needs 10 symbols between the last resource measurement and sending the report. The amount of time that UE needs for CSI report is described in TS 38.214-5.4. Specifically, the UE can use Z2 and Z2′ in TS38.214 Table 5.4-2. In another example, the UE can use Z2 and Z2′ in TS38.214 Table 5.4-2 as a baseline, and the UE can further report the needed relaxation time in units of symbols.

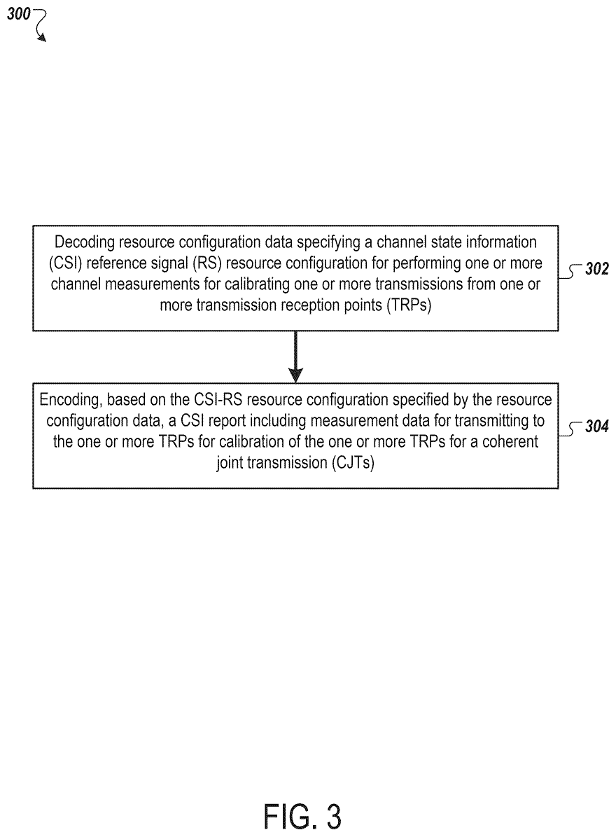

FIG. 3 illustrates a flowchart of an example method 300, according to some implementations. For clarity of presentation, the description that follows generally describes method 300 in the context of the other figures in this description. For example, method 300 can be performed by UE 102 of FIG. 1. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

The method 300 includes decoding (302) resource configuration data specifying a channel state information (CSI) reference signal (RS) resource configuration for performing one or more channel measurements for calibrating one or more transmissions from one or more transmission reception points (TRPs). The method 300 includes encoding (304), based on the CSI-RS resource configuration specified by the resource configuration data, a CSI report including measurement data for transmitting to the one or more TRPs for calibration of the one or more TRPs for a coherent joint transmission (CJTs).

The example method 300 shown in FIG. 3 can be modified or reconfigured to include additional, fewer, or different steps (not shown in FIG. 3), which can be performed in the order shown or in a different order.

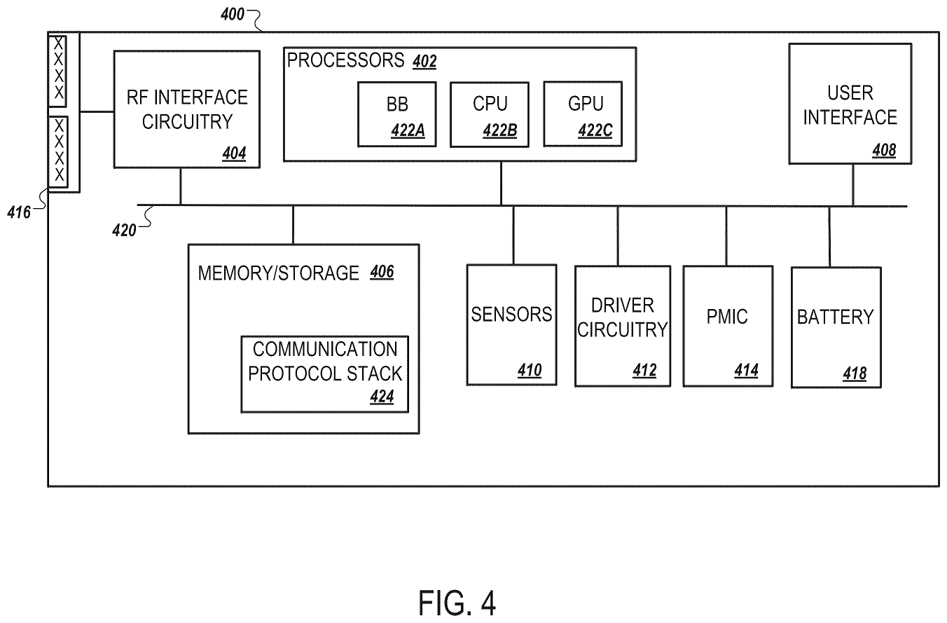

FIG. 4 illustrates an example UE 400, according to some implementations. The UE 400 may be similar to and substantially interchangeable with UE 102 of FIG. 1.

The UE 400 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 400 may include processors 402, RF interface circuitry 404, memory/storage 406, user interface 408, sensors 410, driver circuitry 412, power management integrated circuit (PMIC) 414, one or more antenna(s) 416, and battery 418. The components of the UE 400 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 400. However, some of the components shown may be omitted, additional components may be present, and different arrangement of the components shown may occur in other implementations.

The components of the UE 400 may be coupled with various other components over one or more interconnects 420, which may represent any type of interface, input/output, bus (local, system, or expansion), transmission line, trace, optical connection, etc., that allows various circuit components (on common or different chips or chipsets) to interact with one another.

The processors 402 may include processor circuitry such as, for example, baseband processor circuitry (BB) 422A, central processor unit circuitry (CPU) 422B, and graphics processor unit circuitry (GPU) 422C. The processors 402 may include any type of circuitry or processor circuitry that executes or otherwise operates computer-executable instructions, such as program code, software modules, or functional processes from memory/storage 406 to cause the UE 400 to perform operations as described herein.

In some implementations, the baseband processor circuitry 422A may access a communication protocol stack 424 in the memory/storage 406 to communicate over a 3GPP compatible network. In general, the baseband processor circuitry 422A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 404. The baseband processor circuitry 422A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 406 may include one or more non-transitory, computer-readable media that includes instructions (for example, communication protocol stack 424) that may be executed by one or more of the processors 402 to cause the UE 400 to perform various operations described herein. The memory/storage 406 include any type of volatile or non-volatile memory that may be distributed throughout the UE 400. In some implementations, some of the memory/storage 406 may be located on the processors 402 themselves (for example, L1 and L2 cache), while other memory/storage 406 is external to the processors 402 but accessible thereto via a memory interface. The memory/storage 406 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 404 may include transceiver circuitry and radio frequency front module (RFEM) that allows the UE 400 to communicate with other devices over a radio access network. The RF interface circuitry 404 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 416 and proceed to filter and amplify (with a low-noise amplifier) the signal. The signal may be provided to a receiver of the transceiver that downconverts the RF signal into a baseband signal that is provided to the baseband processor of the processors 402.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 416. In various implementations, the RF interface circuitry 404 may be configured to transmit/receive signals in a manner compatible with NR access technologies.

The antenna(s) 416 may include one or more antenna elements to convert electrical signals into radio waves to travel through the air and to convert received radio waves into electrical signals. The antenna elements may be arranged into one or more antenna panels. The antenna(s) 416 may have antenna panels that are omnidirectional, directional, or a combination thereof to enable beamforming and multiple input, multiple output communications. The antenna(s) 416 may include microstrip antennas, printed antennas fabricated on the surface of one or more printed circuit boards, patch antennas, phased array antennas, etc. The antenna(s) 416 may have one or more panels designed for specific frequency bands including bands in FR1 or FR2.

The user interface 408 includes various input/output (I/O) devices designed to enable user interaction with the UE 400. The user interface 408 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 400.

The sensors 410 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 412 may include software and hardware elements that operate to control particular devices that are embedded in the UE 400, attached to the UE 400, or otherwise communicatively coupled with the UE 400. The driver circuitry 412 may include individual drivers allowing other components to interact with or control various input/output (I/O) devices that may be present within, or connected to, the UE 400. For example, driver circuitry 412 may include a display driver to control and allow access to a display device, a touchscreen driver to control and allow access to a touchscreen interface, sensor drivers to obtain sensor readings of sensors 410 and control and allow access to sensors 410, drivers to obtain actuator positions of electro-mechanic components or control and allow access to the electro-mechanic components, a camera driver to control and allow access to an embedded image capture device, audio drivers to control and allow access to one or more audio devices.

The PMIC 414 may manage power provided to various components of the UE 400. In particular, with respect to the processors 402, the PMIC 414 may control power-source selection, voltage scaling, battery charging, or DC-to-DC conversion.

In some implementations, the PMIC 414 may control, or otherwise be part of, various power saving mechanisms of the UE 400. A battery 418 may power the UE 400, although in some examples the UE 400 may be mounted deployed in a fixed location and may have a power supply coupled to an electrical grid. The battery 418 may be a lithium ion battery, a metal-air battery, such as a zinc-air battery, an aluminum-air battery, a lithium-air battery, and the like. In some implementations, such as in vehicle-based applications, the battery 418 may be a typical lead-acid automotive battery.

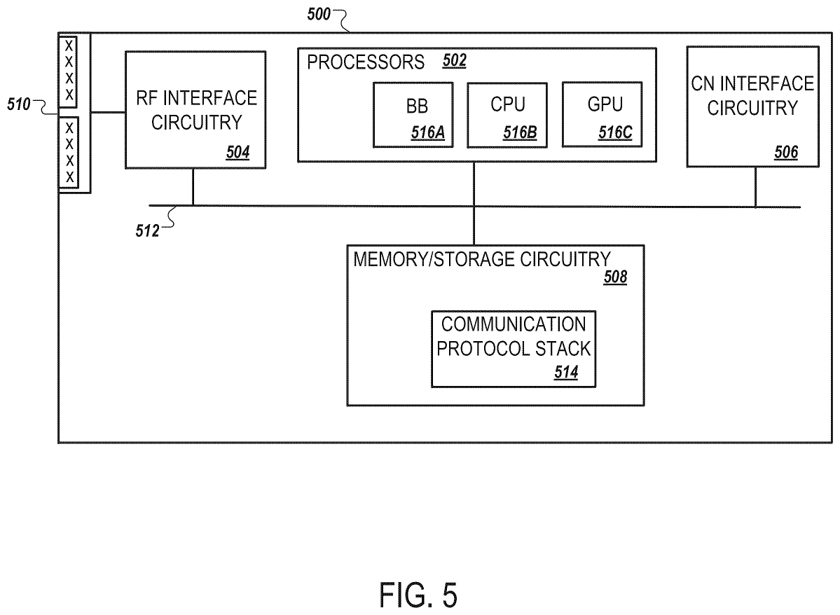

FIG. 5 illustrates an example access node 500 (e.g., a base station or gNB), according to some implementations. The access node 500 may be similar to and substantially interchangeable with base station 104. The access node 500 may include processors 502, RF interface circuitry 504, core network (CN) interface circuitry 506, memory/storage circuitry 508, and one or more antenna(s) 510.

The components of the access node 500 may be coupled with various other components over one or more interconnects 512. The processors 502, RF interface circuitry 504, memory/storage circuitry 508 (including communication protocol stack 514), antenna(s) 510, and interconnects 512 may be similar to like-named elements shown and described with respect to FIG. 4. For example, the processors 502 may include processor circuitry such as, for example, baseband processor circuitry (BB) 516A, central processor unit circuitry (CPU) 516B, and graphics processor unit circuitry (GPU) 516C.

The CN interface circuitry 506 may provide connectivity to a core network, for example, a 5th Generation Core network (5GC) using a 5GC-compatible network interface protocol such as carrier Ethernet protocols, or some other suitable protocol. Network connectivity may be provided to/from the access node 500 via a fiber optic or wireless backhaul. The CN interface circuitry 506 may include one or more dedicated processors or FPGAs to communicate using one or more of the aforementioned protocols. In some implementations, the CN interface circuitry 506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 500 that operates in an NR or 5G system (for example, a gNB), and the term “E-UTRAN node” or the like may refer to an access node 500 that operates in an LTE or 4G system (e.g., an eNB). According to various implementations, the access node 500 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 500 may be implemented as one or more software entities running on server computers as part of a virtual network, which may be referred to as a CRAN and/or a virtual baseband unit pool (vBBUP). In V2X scenarios, the access node 500 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

### Examples

Example 1 includes a method for wireless communication including decoding resource configuration data specifying a channel state information (CSI) reference signal (RS) resource configuration for performing one or more channel measurements for calibrating one or more transmissions from one or more transmission reception points (TRPs); and encoding, based on the CSI-RS resource configuration specified by the resource configuration data, a CSI report including measurement data for transmitting to the one or more TRPs for calibration of the one or more TRPs for a coherent joint transmission (CJTs).

Example 2 includes the method of example 1, wherein decoding a CJT received from the one or more TRPs that are calibrated based on the measurement data.

Example 3 includes the method of any of examples 1 or 2, wherein the coherent joint transmission supports up to four TRPs or TRP groups.

Example 4 includes the method of any of examples 1 to 3, wherein the resource configuration data specifies channel measurement resource (CMR) configurations for reporting a time offset, a frequency offset, or a phase offset for each of the one or more TRPs.

Example 5 includes the method of any of examples 1 to 4, wherein the resource configuration data specifies channel measurement resources in a single CSI-RS resource set for the CSI report, wherein each CSI-RS resource for the one or more TRPs is a part of the single CSI-RS resource set.

Example 6 includes the method of any of examples 1 to 5, wherein the resource configuration data specifies channel measurement resources in a plurality of CSI-RS resource sets for the CSI report, wherein each CSI-RS resource set is configured for a corresponding one of the one or more TRPs, and wherein each CSI-RS resource set is configured as a tracking reference signal (TRS) resource set.

Example 7 includes the method of any of examples 1 to 6, further including encoding, in the UE capability report, a maximum number of different quasi-co-locations sources supported for CSI report for calibration of the one or more TRPs for a coherent joint transmission (CJTs).

Example 8 includes the method of any of examples 1 to 7 wherein the resource configuration data specifies that each TRS resource set of the CSI-RS configuration includes a same number of CSI-RS resources per TRS resource set as each other configured TRS resource set.

Example 9 includes the method of any of examples 1 to 8, wherein the resource configuration data specifies that each TRS resource set of the CSI-RS configuration includes a single slot, each slot comprising two CSI-RS resources.

Example 10 includes the method of any of examples 1 to 9, wherein the resource configuration data specifies that each TRS resource set of the CSI-RS configuration includes two slots, each slot comprising two CSI-RS resources.

Example 11 includes the method of example 10, wherein the two slots are consecutive slots.

Example 12 includes the method of any of examples 1 to 11, wherein the resource configuration data specifies that each TRS resource set of the CSI-RS configuration has a periodic timing domain behavior.

Example 13 includes the method of any of examples 1 to 12, wherein the resource configuration data specifies that each TRS resource set of the CSI-RS configuration has an aperiodic timing domain behavior.

Example 14 includes the method of any of examples 1 to 13, wherein the resource configuration data specifies that each TRS resource set of the CSI-RS configuration includes a same frequency bandwidth as each other TRS resource set.

Example 15 includes the method of any of examples 1 to 14, wherein the resource configuration data specifies that each TRS resource set of the CSI-RS configuration includes a same number of physical resource blocks (PRBs) as each other configured TRS resource set.

Example 16 includes the method of any of examples 1 to 15, wherein the resource configuration data specifies, for each TRS resource set of the CSI-RS configuration, a same starting physical resource block (PRB) index as for each other configured TRS resource set.

Example 17 includes the method of any of examples 1 to 16, wherein the resource configuration data specifies, for each TRS resource set of the CSI-RS configuration, a same set of resource elements (REs) in a frequency domain within a PRB as for each other configured TRS resource set.

Example 18 includes the method of any of examples 1 to 17, wherein the resource configuration data specifies, for each TRS resource set of the CSI-RS configuration, a different set of resource elements (REs) in a frequency domain within a PRB, the different resource set different from each other configured TRS resource set.

Example 19 includes the method example 18, further including encoding a first TRS resource set to be transmitted on a same symbol as a second TRS resource set, the first TRS resource set using a first set of REs in the symbol, and the second TRS resource set using a second set of REs in the symbol.

Example 20 includes the method of any of examples 1 to 19, wherein the resource configuration data specifies that each CSI-RS resource set includes a same number of CSI-RS resources per TRS resource set as each other configured TRS resource set.

Example 21 includes the method of any of examples 1 to 20, wherein the resource configuration data specifies that each CSI-RS resource set includes a single slot, each slot comprising two CSI-RS resources.

Example 22 includes the method of any of examples 1 to 21, wherein the resource configuration data specifies that each CSI-RS resource set includes two slots, each slot comprising two CSI-RS resources.

Example 23 includes the method example 22, wherein the two slots are consecutive slots.

Example 24 includes the method of any of examples 1 to 23, wherein the resource configuration data specifies that each CSI-RS resource set has a periodic timing domain behavior.

Example 25 includes the method of any of examples 1 to 24, wherein the resource configuration data specifies that each CSI-RS resource set has an aperiodic timing domain behavior.

Example 26 includes the method of any of examples 1 to 25, wherein an aperiodic CSI resource set is configured to span more than one slot.

Example 27 includes the method of example 26, wherein each CSI resource of a single CSI-RS resource set is associated with a respective slot offset value, and wherein different CSI-RS resources in the single CSI-RS set are located in different slots, based on the respective slot offset values.

Example 28 includes the method of any of examples 1 to 27, wherein the resource configuration data specifies that each CSI-RS resource set has a semi-persistent timing domain behavior.

Example 29 includes the method of any of examples 1 to 28, wherein the resource configuration data specifies that each CSI-RS resource set includes a same frequency bandwidth as each other CSI-RS resource set.

Example 30 includes the method of any of examples 1 to 29, wherein the resource configuration data specifies that each CSI-RS resource set includes a same number of physical resource blocks (PRBs) as each other configured CSI-RS resource set.

Example 31 includes the method of any of examples 1 to 30, wherein the resource configuration data specifies, for each CSI-RS resource set, a same starting physical resource block (PRB) index as for each other configured CSI-RS resource set.

Example 32 includes the method of any of examples 1 to 31, wherein the resource configuration data specifies, for each CSI-RS resource set, a same set of resource elements (REs) in a frequency domain within a PRB as for each other configured CSI-RS resource set.

Example 33 includes the method of any of examples 1 to 32, wherein the resource configuration data specifies, for each CSI-RS resource set, a different set of resource elements (REs) in a frequency domain within a PRB, the different resource set different from each other configured CSI-RS resource set.

Example 34 includes the method of any of examples 1 to 33, further including encoding a first CSI-RS resource set to be transmitted on a same symbol as a second TRS resource set, the first CSI-RS resource set using a first set of REs in the symbol, and the second CSI-RS resource set using a second set of REs in the symbol.

Example 35 includes the method of any of examples 1 to 34, further including decoding a configuration for the CSI report, the CSI report specifying a timing offset, a frequency offset, a phase offset, or a combination of any of the timing offset, the frequency offset, and the phase offset.

Example 36 includes the method of any of examples 1 to 34, wherein the configuration of the CSI report specifies a timing unit for reporting the timing offset.

Example 37 includes the method of example 36, wherein the timing unit is based on a cyclic prefix duration.

Example 38 includes the method of example 36, wherein the timing unit is based on an inverse of a sub-carrier spacing of a measurement resource used for performing a measurement of the timing offset.

Example 39 includes the method of example 36, wherein the timing unit is based on a symbol duration.

Example 40 includes the method of example 39, wherein the symbol duration is based on an inverse of a sub-carrier spacing and cyclic prefix value of a measurement resource.

Example 41 includes the method of example 39, wherein the symbol duration is based on an average value of the symbol duration in a slot.

Example 42 includes the method of any of examples 1 to 41, wherein the configuration of the CSI report specifies a frequency unit for reporting the frequency offset.

Example 43 includes the method of example 42, wherein the frequency unit is based on a sub-carrier spacing of a measurement resource.

Example 44 includes the method of example 43, wherein the frequency unit is based on a parts per million (ppm) of a carrier frequency.

Example 45 includes the method of any of examples 1 to 44, wherein the configuration of the CSI report specifies a phase offset reporting configuration for reporting the phase offset.

Example 46 includes the method of example 45, wherein the phase offset reporting configuration supports a wideband phase report only.

Example 47 includes the method of example 45, wherein the phase offset reporting configuration supports both a wideband phase report and a set of sub-band phase reports.

Example 48 includes the method of example 47, wherein a size of each sub-band for the sub-band phase reports is based on a channel quality indicator (CQI) sub-band size.

Example 49 includes the method of example 47, wherein a size of each sub-band for the sub-band phase reports is based on a pre-coding matrix indicator (PMI) sub-band size.

Example 50 includes the method of example 47, wherein a size of each sub-band for the sub-band phase reports is based on a bandwidth part (BWP) of the measurement signal or a bandwidth of a channel measurement resource including a CSI-RS.

Example 51 includes the method of example 45, wherein the phase offset reporting configuration specifies that each sub-band phase offset is reported independently to the TRP.

Example 52 includes the method of example 45, wherein the phase offset reporting configuration specifies that a reference phase offset and phase offset step size are reported to the TRP.

Example 53 includes the method of any of examples 1 to 52, wherein the configuration of the CSI report specifies that at least two offsets selected from a group consisting of a phase offset, a timing offset, and a frequency offset are reported in a same CSI report.

Example 54 includes the method of any of examples 1 to 53, wherein the configuration of the CSI report specifies that, when a phase offset is not being reported, a timing offset and a frequency offset are reported in a same TRS resource set.

Example 55 includes the method of any of examples 1 to 54, wherein the configuration of the CSI report specifies that, when a phase offset is being reported with a time offset or a frequency offset, the phase offset is reported in the same TRS resource set as the time offset or the frequency offset.

Example 56 includes the method of any of examples 1 to 55, wherein the configuration of the CSI report specifies that, when a phase offset is being reported with a time offset or a frequency offset, the phase offset is reported in a CSI resource independent of a TRS resource set used for reporting the time offset or the frequency offset.

Example 57 includes the method of any of examples 1 to 56, wherein the configuration of the CSI report specifies that a UE is allowed to select any TRP as a reference TRP, and wherein, for each offset report, the reference TRP offset is independently reported.

Example 58 includes the method of any of examples 1 to 57, wherein, when the configuration of the CSI report specifies a priority for simultaneous offset reports when a payload size of the offset reports exceeds a size allocated for uplink payload.

Example 59 includes the method of example 58, wherein the priority is fixed.

Example 60 includes the method of example 58, wherein the priority is configured in the CSI report.

Example 61 includes the method of any of examples 1 to 60, wherein the configuration of the CSI report specifies that all simultaneous offset reports are omitted when an uplink payload is not large enough to carry all of the simultaneous offset reports together.

Example 62 includes the method of any of examples 1 to 61, wherein a CSI-RS resource is configured as a channel measurement resource, and wherein a CSI process unit (CPU) count is associated with a UE capability.

Example 63 includes the method of example 62, wherein each configured CSI-RS resource is counted as 1 CPU for UE capability reporting.

Example 64 includes the method of example 62, wherein all configured CSI-RS resources are together counted as 1 CPU for UE capability reporting.

Example 65 includes the method of example 62, wherein the CPU count is decoded as the UE capability.

Example 66 includes the method of example 62, wherein the CPU count is based on a number of TRPs.

Example 67 includes the method of any of examples 1 to 66, wherein a TRS resource set is configured as a channel measurement resource, and wherein a CSI process unit (CPU) count is associated with a UE capability.

Example 68 includes the method of example 67, wherein each configured TRS resource set is counted as 1 CPU for UE capability reporting.

Example 69 includes the method of example 67, wherein the CPU count is based on a number CSI-RS resources.

Example 70 includes the method of example 67, wherein all configured TRS resource sets are together counted as 1 CPU for UE capability reporting.

Example 71 includes the method of example 67, wherein the CPU count is decoded as the UE capability.

Example 72 includes the method of example 67, wherein the CPU count is based on a number of TRPs.

Example 73 includes the method of any of examples 1 to 72, wherein multiple offsets are configured for being reported in the CSI report, and wherein a CPU count of each offset is determined independently for a total CPU count.

Example 74 includes the method of any of examples 1 to 73, wherein multiple offsets are configured for being reported in the CSI report, and wherein a CPU count of each offset is determined jointly for a total CPU count.

Example 75 includes one or more processors configured to perform the method of any of examples 1 to 74.

Example 76 includes a non-transitory computer storage medium encoded with instructions for execution one or more processors configured to perform the method of any of examples 1 to 74.

Example 77 includes a system comprising one or more storage devices on which are stored instructions that are executable by one or more processors to perform the method of any of examples 1 to 74.

Example 78 includes an apparatus comprising one or more processors configured to perform the method of any of examples 1 to 74.

Example 79 includes an apparatus comprising one or more baseband processors configured to perform the method of any of examples 1 to 74.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-20. (canceled)

21. One or more processors configured to perform operations for wireless communication, the operations comprising:
decoding resource configuration data specifying a channel state information (CSI) reference signal (RS) resource configuration for performing one or more channel measurements for calibrating one or more transmissions from one or more transmission reception points (TRPs); and
encoding, based on the CSI-RS resource configuration specified by the resource configuration data, a CSI report including measurement data for transmitting to the one or more TRPs for calibration of the one or more TRPs for a coherent joint transmission (CJTs).

22. The one or more processors of claim 21, wherein an aperiodic CSI resource set is configured to span more than one slot.

23. The one or more processors of claim 22, wherein each CSI resource of a single CSI-RS resource set is associated with a respective slot offset value, and wherein different CSI-RS resources in the single CSI-RS set are located in different slots, based on the respective slot offset values.

24. The one or more processors of claim 21, wherein the configuration of the CSI report specifies a timing unit for reporting the timing offset.

25. The one or more processors of claim 24, wherein the timing unit is based on a cyclic prefix duration.

26. The one or more processors of claim 24, wherein the timing unit is based on an inverse of a sub-carrier spacing of a measurement resource used for performing a measurement of the timing offset.

27. The one or more processors of claim 24, wherein the timing unit is based on a symbol duration.

28. The one or more processors of claim 27, wherein the symbol duration is based on an inverse of a sub-carrier spacing and cyclic prefix value of a measurement resource.

29. The one or more processors of claim 27, wherein the symbol duration is based on an average value of the symbol duration in a slot.

30. The one or more processors of claim 21, wherein the configuration of the CSI report specifies a phase offset reporting configuration for reporting the phase offset.

31. The one or more processors of claim 30, wherein the phase offset reporting configuration supports a wideband phase report only.

32. The one or more processors of claim 30, wherein the phase offset reporting configuration supports both a wideband phase report and a set of sub-band phase reports.

33. The one or more processors of claim 32, wherein a size of each sub-band for the sub-band phase reports is based on a channel quality indicator (CQI) sub-band size.

34. The one or more processors of claim 32, wherein a size of each sub-band for the sub-band phase reports is based on a pre-coding matrix indicator (PMI) sub-band size.

35. The one or more processors of claim 32, wherein a size of each sub-band for the sub-band phase reports is based on a bandwidth part (BWP) of the measurement signal or a bandwidth of a channel measurement resource including a CSI-RS.

36. The one or more processors of claim 30, wherein the phase offset reporting configuration specifies that each sub-band phase offset is reported independently to the TRP.

37. The one or more processors of claim 30, wherein the phase offset reporting configuration specifies that a reference phase offset and phase offset step size are reported to the TRP.

38. The one or more processors of claim 21, wherein the configuration of the CSI report specifies a priority for simultaneous offset reports when a payload size of the offset reports exceeds a size allocated for uplink payload.

39. An apparatus comprising circuitry for one or more baseband processors and memory storing instructions that, when executed by the one or more processors, is configured to cause the one or more processors to perform operations comprising:
decoding resource configuration data specifying a channel state information (CSI) reference signal (RS) resource configuration for performing one or more channel measurements for calibrating one or more transmissions from one or more transmission reception points (TRPs); and
encoding, based on the CSI-RS resource configuration specified by the resource configuration data, a CSI report including measurement data for transmitting to the one or more TRPs for calibration of the one or more TRPs for a coherent joint transmission (CJTs).

40. The apparatus of claim 39, wherein the configuration of the CSI report indicates a phase offset reporting configuration for reporting the phase offset.
